(19) United States
(12) Patent Application Publication
(10) Pub. No.: US 2019/0204467 A1
(43) Pub. Date: Jul. 4, 2019

(54) Method and Apparatus for a Cloud-Based Oil Well Monitoring System

(71) Applicant: Power Monitors, Inc., Mt. Crawford, VA (US)

(72) Inventors: Edward Curt, Houston, TX (US); Christopher Fisher Mullins, Penn Laird, VA (US)

(21) Appl. No.: 16/237,072

(22) Filed: Dec. 31, 2018

Related U.S. Application Data
(60) Provisional application No. 62/612,613, filed on Dec. 31, 2017.

(51) Int. Cl. G01V 3/38; G01V 1/50; G01V 3/34; E21B 47/16; E21B 47/12; E21B 47/06; E21B 47/10

(52) U.S. Cl. CPC G01V 3/38; G01V 1/50; G01V 3/34; G01V 2210/74; E21B 47/122; E21B 47/065; E21B 47/10; E21B 47/16

(57) ABSTRACT

A method and apparatus for cloud-based oil and gas well monitoring. The solution comprises a concentrator located electrically on the input side of an artificial lift drive motor or pump, and measures single or three-phase voltage, current and power. The concentrator includes a communication means, antenna, power supply, microprocessor, and voltage and current transducer means. The concentrator sends status and measurement information to the server system. The server system processes and stores concentrator data, and provides a web interface for a user to view live data, analyze graphs and reports, view a map-based UI showing overall status of devices and wells, and configure alerts based on conditions. An aspect adds a Smart Artificial Lift Receiver that interfaces with various sensors, and connects to a concentrator through an interface. The augmented concentrator links with the smart pump concentrator, processing the sensor data similarly to the voltage and current data already measured.

### CROSS-REFERENCE TO RELATED APPLICATIONS

This application claims the benefit of U.S. Provisional Application No. 62/612,613 filed on Dec. 31, 2017, which is hereby incorporated by reference in its entirety for all purposes as if fully set forth herein.

### FIELD OF THE DISCLOSURE

The disclosure relates to a method for a cloud-based oil well monitoring system. The disclosure also relates to an apparatus for a cloud-based oil well monitoring system.

### BACKGROUND OF THE DISCLOSURE

Extracting oil and gas from underground wells often requires a complex system to encourage reservoir flow from within the well up to the surface known as artificial lift. This system, operating under varying rough conditions, requires careful supervision and control to maximize production while maintaining safe and efficient operation of artificial lift equipment. Traditionally, artificial lift and/or pump status is monitored manually with on-site personnel, or with a rudimentary supervisory control and data acquisition (SCADA) system. Parameters such as downhole conditions (temperature, pressure, etc.) are difficult to monitor. Present solutions therefore fail to provide accurate and timely data for these and other variables.

Accordingly, a well monitoring system that provides accurate and timely data is needed.

### SUMMARY OF THE DISCLOSURE

The foregoing needs are met, to a great extent, by the disclosure, wherein in one aspect a method and apparatus for a cloud-based oil well monitoring system technique is provided.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an oil well monitoring system including: a concentrator located at an oil well and the concentrator configured to collect oil well related data from oil well equipment. The oil well monitoring system also includes the concentrator including a processor to process the oil well related data. The oil well monitoring system also includes the concentrator including a modem to transmit the oil well related data. The oil well monitoring system also includes a server system configured to receive the oil well related data from the concentrator. The oil well monitoring system also includes the server system configured to provide a web-based interface to a user that includes at least the oil well related data. Other aspects of this aspect include corresponding computer systems, apparatus, and computer programs recorded on one or more computer storage devices, each configured to perform the actions of the methods.

Implementations may include one or more of the following features. The oil well monitoring system where the concentrator is further configured to measure power related data that includes at least a voltage, a current, and a power delivered from a utility to the oil well equipment. The oil well monitoring system where the concentrator is further configured to collect the oil well related data that includes measurements from at least one sensor associated with the oil well equipment, apply user settable thresholds to the oil well related data, and respond to external commands. The oil well monitoring system may also include where the server system is further configured to generate commands to the oil well equipment and send the commands to the concentrator. The oil well monitoring system may also include where the concentrator is further configured to receive the commands to the oil well equipment from the server system. The oil well monitoring system may also include where the concentrator further includes a command port configured to relay the commands to the oil well equipment. The oil well monitoring system where the server system is configured to store all measured values as sent from the concentrator. The oil well monitoring system may also include where the concentrator is further configured to collect the oil well related data that includes measurements from at least one sensor associated with the oil well equipment, apply user settable thresholds to the oil well related data, and generate and send alerts to the server system. The oil well monitoring system may also include the server system is configured to process the alerts from the concentrator including sending immediate message notices to a distribution list. The oil well monitoring system may also include where the server system is configured to operate with a plurality of the concentrators. The oil well monitoring system may also include where the server system is configured to provide a map-based graphical display of the concentrators. The oil well monitoring system where the server system is configured to provide graphical and report-based data analysis tools for a user to view and analyze at least the oil well related data. The oil well monitoring system where the server system is further configured to provide a control interface to send commands or query status of the oil well equipment connected to the concentrator. The oil well monitoring system where the server system is further configured to provide a SCADA interface configured to allow an external SCADA master to query information and send commands to the oil well equipment connected to the concentrator. The oil well monitoring system further including: a smart artificial lift receiver that is configured to receive measurements from at least one sensor associated with oil well equipment. The oil well monitoring system may also include the smart artificial lift receiver is further configured to be directly linked to the concentrator and transmit data to the server system. Implementations of the described techniques may include hardware, a method or process, or computer software on a computer-accessible medium.

One general aspect includes an oil well monitoring system including: a concentrator located at an oil well and the concentrator configured to collect oil well related data from oil well equipment. The oil well monitoring system also includes the concentrator including a processor to process the oil well related data. The oil well monitoring system also includes the concentrator including a modem to transmit the oil well related data. The oil well monitoring system also includes a server system configured to receive the oil well related data from the concentrator. The oil well monitoring system also includes the server system configured to provide a web-based interface to a user that includes at least the oil well related data. The oil well monitoring system also includes where the concentrator is further configured to measure power related data that includes at least a voltage, a current, and a power delivered from a utility to the oil well equipment. The oil well monitoring system also includes where the concentrator is further configured to collect the oil well related data that includes measurements from at least one sensor associated with the oil well equipment, apply user settable thresholds to the oil well related data, and respond to external commands. The oil well monitoring system also includes where the server system is further configured to generate commands to the oil well equipment and send the commands to the concentrator. The oil well monitoring system also includes where the concentrator is further configured to receive the commands to the oil well equipment from the server system. The oil well monitoring system also includes where the concentrator further includes a command port configured to relay the commands to the oil well equipment. Other aspects of this aspect include corresponding computer systems, apparatus, and computer programs recorded on one or more computer storage devices, each configured to perform the actions of the methods.

Implementations may include one or more of the following features. The oil well monitoring system where the server system is configured to store all measured values as sent from the concentrator. The oil well monitoring system may also include where the concentrator is further configured to collect the oil well related data that includes measurements from at least one sensor associated with the oil well equipment, apply user settable thresholds to the oil well related data, and generate and send alerts to the server system. The oil well monitoring system may also include the server system is configured to process the alerts from the concentrator including sending immediate message notices to a distribution list. The oil well monitoring system may also include where the server system is configured to operate with a plurality of the concentrators. The oil well monitoring system may also include where the server system is configured to provide a map-based graphical display of the concentrators. The oil well monitoring system may also include where the server system is configured to provide graphical and report-based data analysis tools for a user to view and analyze at least the oil well related data. The oil well monitoring system further including: a smart artificial lift receiver that is configured to receive measurements from at least one sensor associated with oil well equipment. The oil well monitoring system may also include the smart artificial lift receiver is further configured to be directly linked to the concentrator and transmit data to the server system. Implementations of the described techniques may include hardware, a method or process, or computer software on a computer-accessible medium.

One general aspect includes an oil well monitoring process including: collecting oil well related data from oil well equipment with a concentrator located at an oil well. The oil well monitoring process also includes processing the oil well related data with a processor implemented by the concentrator. The oil well monitoring process also includes transmitting the oil well related data with a modem implemented by the concentrator. The oil well monitoring process also includes receiving the oil well related data from the concentrator with a server system. The oil well monitoring process also includes providing a web-based interface to a user that includes at least the oil well related data with the server system. Other aspects of this aspect include corresponding computer systems, apparatus, and computer programs recorded on one or more computer storage devices, each configured to perform the actions of the methods.

Implementations may include one or more of the following features. The oil well monitoring process where the concentrator is further configured to measure power related data that includes at least a voltage, a current, and a power delivered from a utility to the oil well equipment. The oil well monitoring process where the concentrator is further configured to collect the oil well related data that includes measurements from at least one sensor associated with the oil well equipment, apply user settable thresholds to the oil well related data, and respond to external commands. The oil well monitoring process. The oil well monitoring process may also include where the server system is further configured to generate commands to the oil well equipment and send the commands to the concentrator. The oil well monitoring process may also include where the concentrator is further configured to receive the commands to the oil well equipment from the server system. The oil well monitoring process may also include where the concentrator further includes a command port configured to relay the commands to the oil well equipment. The oil well monitoring process where the server system is configured to store all measured values as sent from the concentrator. Implementations of the described techniques may include hardware, a method or process, or computer software on a computer-accessible medium.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates an exemplary overview of a well site, concentrator, smart artificial lift receiver, and external sensors according to aspects of the disclosure.

FIG. 2 illustrates an exemplary diagram of a concentrator according to aspects of the disclosure.

FIG. 3 illustrates an exemplary diagram of a web front end generated according to aspects of the disclosure.

FIG. 4 illustrates an exemplary diagram of a server system according to aspects of the disclosure.

FIG. 5 illustrates an exemplary diagram of a Smart Artificial Lift Receiver (SALR) according to aspects of the disclosure.

FIG. 6 illustrates an exemplary process for operating a concentrator according to aspects of the disclosure.

FIG. 7 illustrates an exemplary process for operating a Smart Artificial Lift Receiver (SALR) according to aspects of the disclosure.

FIG. 8 illustrates an exemplary process for operating a web server on the server system according to aspects of the disclosure.

FIG. 9 illustrates an exemplary process for receiving data from a concentrator at the server system according to aspects of the disclosure.

FIG. 10 illustrates an exemplary process for operating an external interface on the server system according to aspects of the disclosure.

### DETAILED DESCRIPTION

The disclosure will now be described with reference to the drawing figures, in which like reference numerals refer to like parts throughout. Aspects of the disclosure advantageously provide a method and apparatus for a cloud-based oil well monitoring system.

Aspects herein provide solutions for providing accurate and timely information and data points concerning oil and gas wells employing artificial lift systems. Monitoring artificial lift status and current operating conditions reveals important information about the pump or lift system health, as well as the well itself. Further, the ability to measure and analyze sensor data such as pressure, flow rate, temperature, etc. at the top of the well, and downhole, allows for advance notice of equipment failures and precise tracking of the well condition. A centralized, cloud-based system for receiving, storing, and analyzing this data, and sending real-time alerts (including but not limited to, e.g., e-mail and SMS) based on specific conditions, greatly improves the current state of the art in hydrocarbon production. The disclosure described here provides such as system.

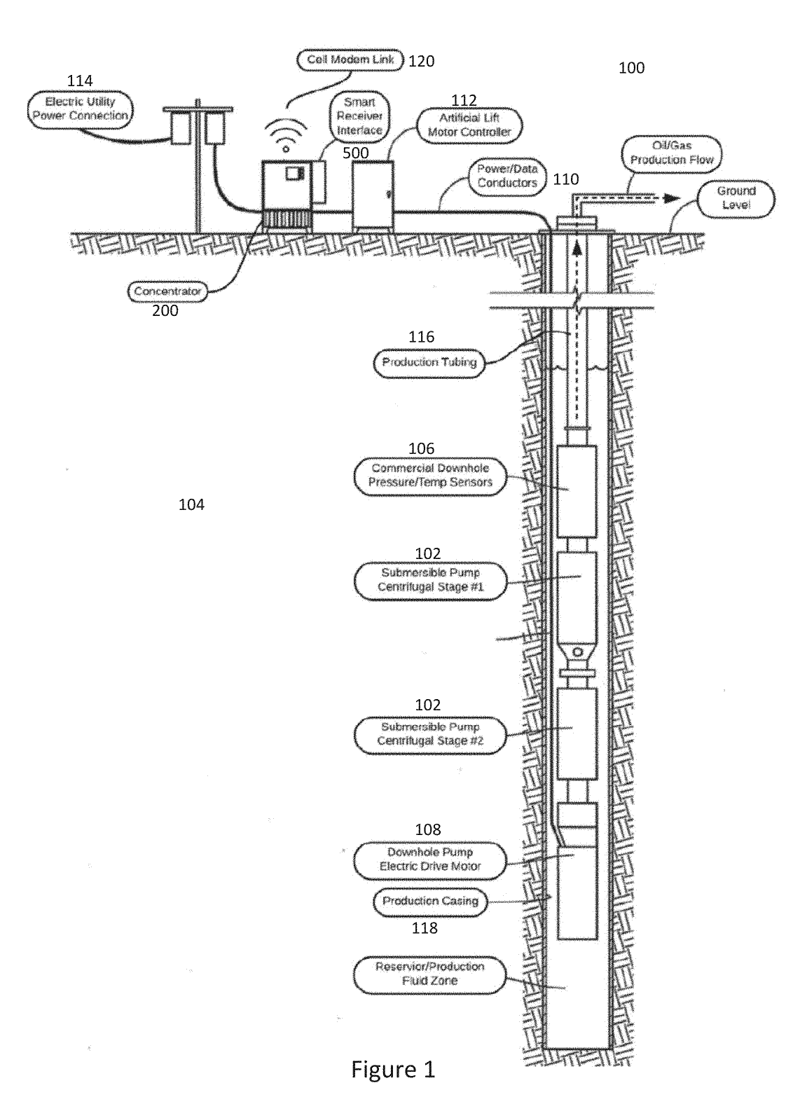

FIG. 1 illustrates an exemplary overview of a well site, concentrator, smart artificial lift receiver, and external sensors according to aspects of the disclosure.

The Artificial Lift System 104

An oilfield well completion 100 utilizes one or more methods of artificial lift, a technology that increases downhole pressure and helps force reservoir production out of the well. Several commercially available methods include but are not limited to beam or sucker rod pumping, hydraulic pumping, electric submersible pumps (ESPs), gas lift, and/or the like. Each of these technologies, while different in their physical method of production, share two fundamental common elements: an electric drive system, such as an AC electric drive system, and one or more sensors 106 configured and used to start/stop electric motors 108 or pumps 102 to control the well's production. Key indicators of overall well performance and system health can be derived from measurement, monitoring, and controlling the electric drive system and the sensors 106, such as well sensors. The ability to collect, store, concentrate, and report the data to remote operators can provide great insight into the performance of many wells across a large oilfield, production basin, and/or the like.

Aspects of the artificial lift systems 104 include a pump 102, either a downhole pump (as in an ESP or hydraulic lift), or surface-based pump (as in gas lift or sucker rod-pumps); an AC electric motor 108 to drive the pump 102; power conductors 110 that lead from the electric motor 108 to a control station or system; an artificial lift Motor Controller (MC) system 112 that may include any one or combination of Variable Frequency Drive (VFD) motor controllers, fixed-speed motor controllers, gas lift compressor motor controllers, hydraulic lift drive motor controllers, and/or the like; one or more valves controlling the operation of the Artificial Lift System 104 or controlling the production of the well; incoming single or three-phase power from an electric utility 114 used to drive the motor 108 of whichever Artificial Lift System 104 has been employed; and/or the like.

Sensors 106 and Measurements

A variety of sensors 106 may be implemented and configured to monitor or control the Artificial Lift System 104 and may also be located at the surface within or around the wellhead performing measurements including, but not limited to, fluid and/or gas flow rate, fluid and/or ambient temperature, surface estimated/corrected downhole pressure, surface estimated/corrected multi production zone pressures, true surface pressure and/or annular region pressure, production control valve positions, artificial lift valve positions, production storage tank capacity and/or status, and the like.

The sensors 106 may also be located downhole within the pump 102 (for ESPs or hydraulic lift), near a gas inlet valve or port (for gas lift systems), or the like. The sensors 106 may be configured for measuring downhole pressure and/or temperature, and (in applicable systems) the motor 108 and/or the pump 102 status such as torque, RPM, bending moment, more detailed vibration and cavitation information, and the like.

The sensors 106 may also be configured for measuring production (tubing 116) pressure and/or temperature alone or in addition to annular (casing 118) pressure and/or temperature and may also be deployed in standalone downhole gauge systems physically separated from, in addition to, or in conjunction with any downhole pump 102 or Artificial Lift System 104.

The sensors 106 and/or standalone gauge systems may communicate their pressure and/or temperature measurements to the surface using one or more available methods such as telemetry propagating electromagnetic (E/M) waves through the earth; telemetry involving transmission of acoustic longitudinal and/or torsional and/or shear-mode solid waves oscillating within infrasonic, audible or ultrasonic frequencies propagating through one or more sections of production or surface tubing 116 and/or casing 118; telemetry involving transmission of positive or negative pressure waves through fluid and/or gas columns in either or both the production (tubing 116) or annular (casing 118) regions of the well completion; and/or utilize a wired or wireless communication channel as defined herein. Any of the sensors 106 may be pre-existing in a well, installed during the workover of a well, they may be incorporated in an aspect of the system of this disclosure, or the like.

The system of the disclosure may include a concentrator 200, a server system 400 providing a web-based interface to the user, and in aspects, a Smart Artificial Lift Receiver (SALR) 500 that may receive measurements from additional sensors 106 and may feed that data to the concentrator 200. The server system 400 may be shared among multiple wells, but each well may use a dedicated concentrator 200 and, in aspects, an SALR 500. An aspect of the overall system is depicted in FIG. 1.

The Concentrator 200

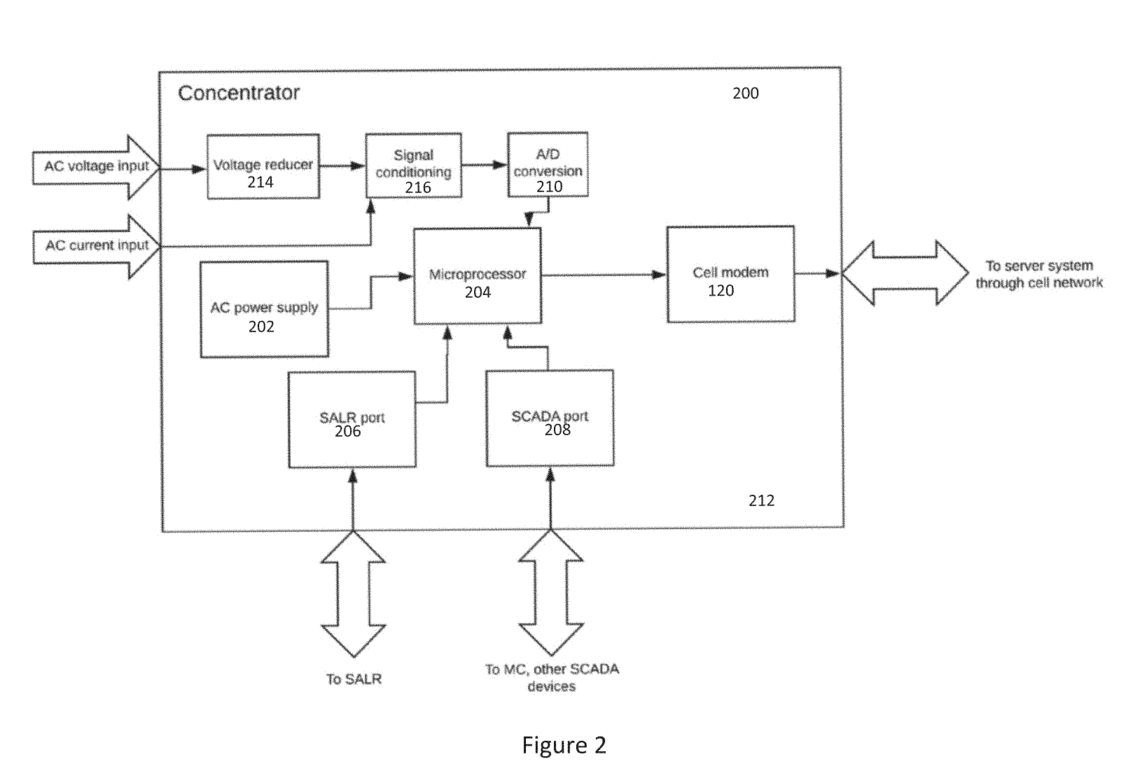

FIG. 2 illustrates an exemplary diagram of a concentrator according to aspects of the disclosure.

The concentrator 200 may be located at the top of the well, and can be near the artificial lift system Motor Controller (MC) 112. FIG. 2 illustrates an exemplary diagram of the concentrator 200. The concentrator 200 may perform several functions and/or include:

1. Direct measurement of the utility 114 single or three-phase voltage, current, and power as delivered to the motor controller 112.

2. An embedded processor 204 for collecting measurements, applying user settable thresholds, and responding to external commands.

3. An embedded cellular or satellite modem 120, or other wireless communication technology, for relaying data to the cloud-based system 400.

4. Communication ports (e.g. RS-485, Ethernet, RS-232, or wireless links) for interfacing with external sensors 106.

5. A command port for relaying commands to the MC 112 or other compatible control devices.

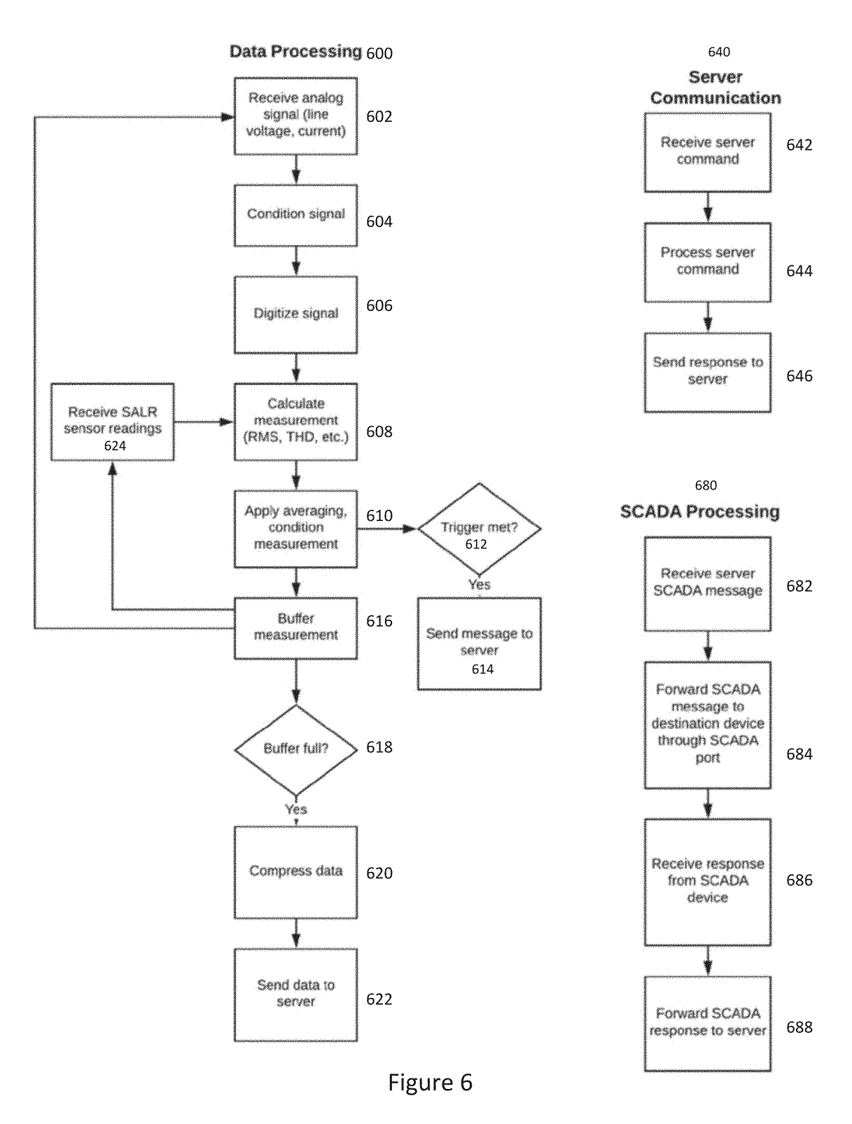

The concentrator 200 may be associated with a single well completion 100 and artificial lift system 104. The concentrator 200 may collect data from all compatible sensors 106, may add the built-in voltage/current/power measurements, and packages this data for streaming to the cloud data collection system 400. Additionally, the concentrator 200 may apply thresholds to any measured or sensed parameter, and send alerts to the cloud-based system 400, and/or be configured to automatically send commands through the command port. FIG. 6 illustrates a basic operational flow for the concentrator 200.

The Server System 400

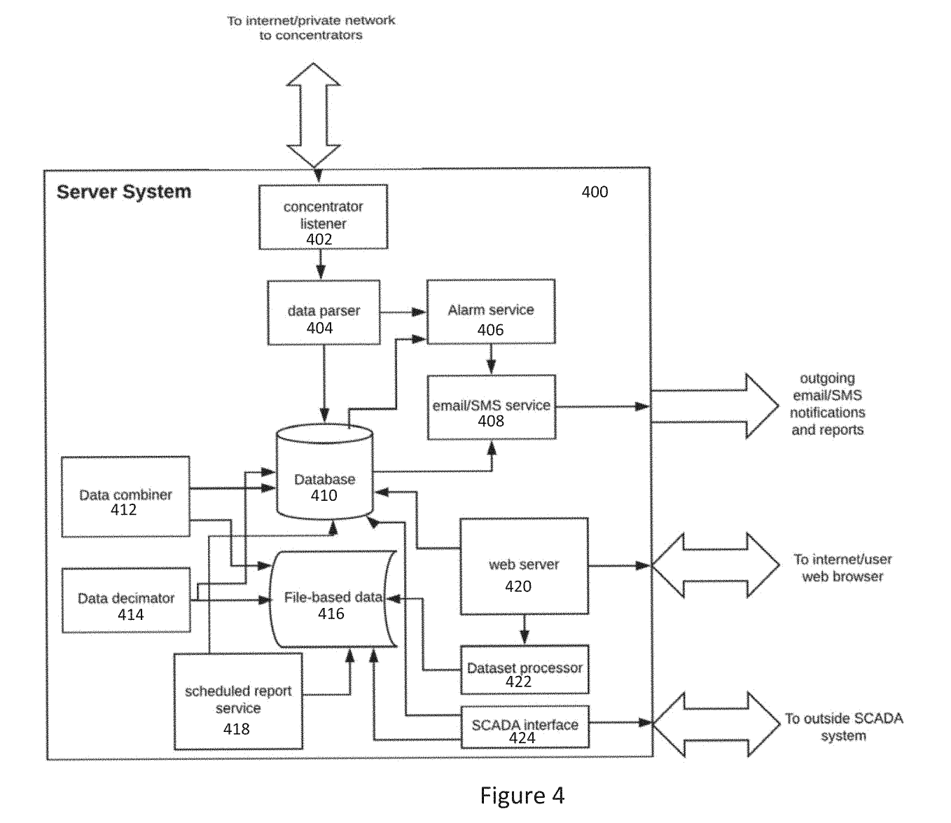

FIG. 4 illustrates an exemplary diagram of a server system according to aspects of the disclosure.

The server system 400 may be implemented as a cloud-based server system, and may be a collection of virtual machines and processes, with one aspect illustrated in FIG. 4. The server system 400 may perform several functions:

1. Receives and parses data from all concentrators 200 as it streams in to the server system 400.

2. Stores all measured values as sent from the concentrators 200.

3. Processes any alerts from the concentrators 200, including sending immediate message notices (e.g. email, text message, app) to any triggered distribution list.

4. Provides a map-based graphical display of all the concentrators 200 associated with a specific account.

5. Provides graphical and report-based data analysis tools for the user to view and analyze sensor data.

6. May provide a control interface to send commands or query status of the MC 112 itself, or any other compatible device connected to a remote concentrator 200.

7. May provide a SCADA interface to allow an external SCADA master to query information and send commands to remote devices, with the server system 400 and the remote concentrators 200 acting as a bridge.

The user interaction with the server system 400 may be through a standard web browser. By deploying the concentrators 200 and, in aspects, the SALRs 500 throughout an oilfield, production operations may be managed and analyzed remotely with a standard web browser. Real-time status is available online, text and alerts provide may provide instant notification of a problem, and historical data allows for long-term and predictive analysis of oil/gas production operations.

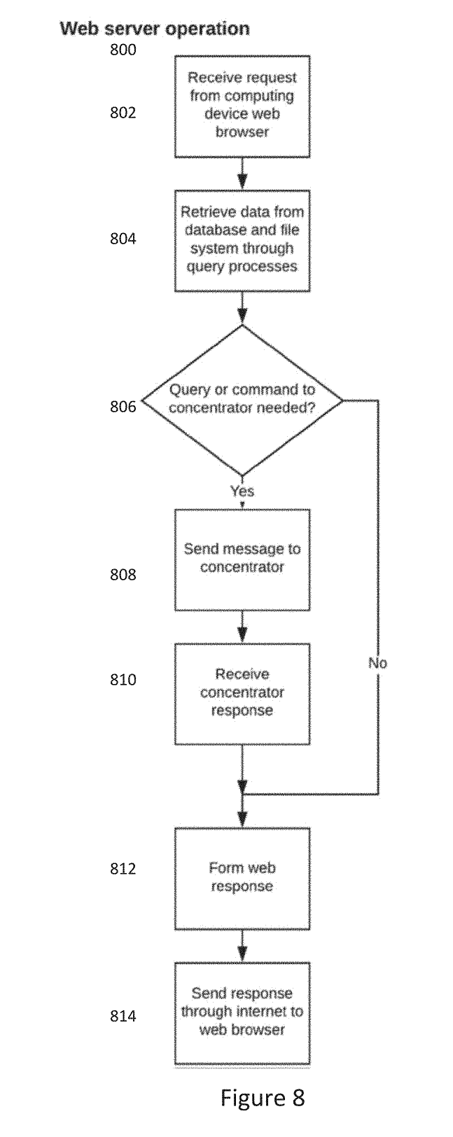

The server system 400 may further include one or more the following components, a concentrator listener 402, a data parser 404, an alarm service 406, an email/SMS service 408, a database 410, a data combiner 412, a data decimeter 414, a file-based data storage 416, a scheduled report service 418, a Web server 420, a data set processor 422, a SCADA interface 424, and the like. FIGS. 8, 9, and 10 depict basic flowcharts of operation for processes within the server system 400.

Smart Artificial Lift Receiver 500

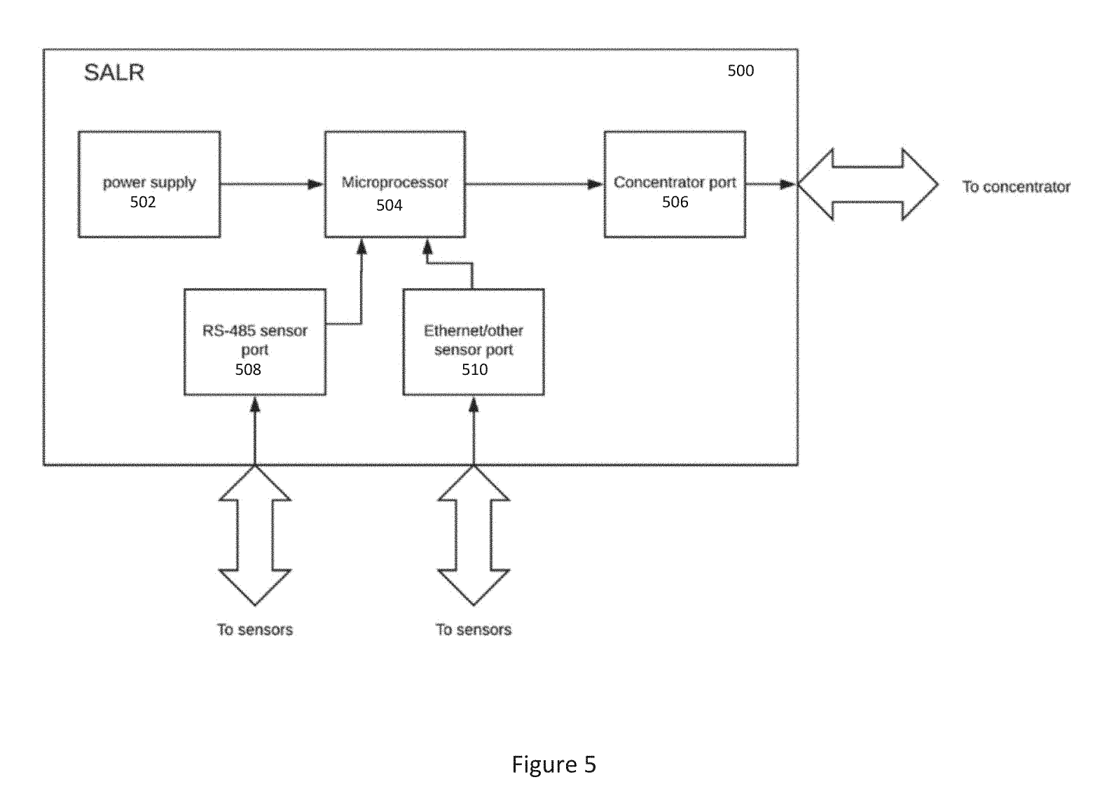

FIG. 5 illustrates an exemplary diagram of a Smart Artificial Lift Receiver (SALR) according to aspects of the disclosure.

The Smart Artificial Lift Receiver (SALR 500) may receive production related measurements from the sensors 106 and may feed that data into the concentrator 200. In aspects, the data fed to the concentrator 200 can be calculated or derived from production related measurements. In alternative or complementary aspects, the data fed to the concentrator 200 can be the measurements themselves. The SALR 500 can be located near the wellhead and can connect between the sensors 106 and the concentrator 200. FIG. 5 illustrates a diagram of an SALR 500 aspect. The SALR 500 may perform several functions:

1. Interface with remote sensor 106 or gauge surface equipment to query and receive sensor data.

2. Provides a serial data or SCADA interface compatible with many available downhole or surface based sensor receivers.

3. Allow data measured by downhole cable-based, wireless or acoustic gauges to be directly linked into the concentrator 200 and transmitted to the server system 400.

4. Allows measurements from most available sensors 106 at the wellsite to be collected and aggregated using a single device.

5. Provides a method of incorporating these downhole measurements into a broader artificial lift control system.

The SALR 500 may be implemented with a power supply 502, a microprocessor 504, a concentrator port 506, a first sensor port 508, a second sensor port 510, and the like.

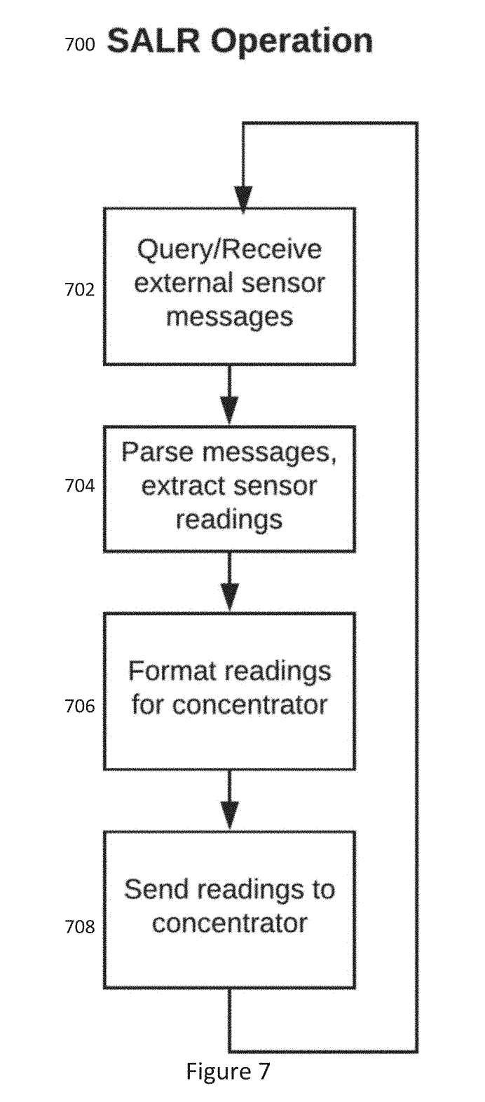

FIG. 7 illustrates an exemplary process for operating a Smart Artificial Lift Receiver (SALR) according to aspects of the disclosure.

In particular, the SALR 500 may implement a SALR operation process 700. The SALR operation process 700 may include operating to Query/Receive external sensor messages 702, parse messages and extract sensor readings 704, format readings for the concentrator 706, and send readings to the concentrator 708.

Operational Aspects

The concentrator 200 may be implemented as a small, standalone, weatherproof device with an internal power supply 202, a data connection (e.g. one or more of a cell modem 120, satellite modem 120, or other data connection), an antenna, a microprocessor 204, and the like. In one aspect, the cell modem 120 may utilize wireless data as defined herein.

The concentrator 200 may incorporate an internal AC power supply 202, designed to be powered from the same AC voltage being measured. In one aspect, the power supply 202 may be rated for 60-300VAC to ground, or 60-600VAC, with a CAT III or CAT IV rating.

The concentrator 200 may use a standard microprocessor 204 and may include embedded technology to control the cell and/or satellite modems 120, process data from external ports, interface to the A/D converters 210, perform real-time voltage, current, and power calculations, and the like. In one aspect, the external ports may include a SALR port 206 and/or a SCADA port 208.

As an example, the processor 204 may be implemented as an ST Micro STM32F205 (available from STMicroelectronics, Geneva, Switzerland) or similar microprocessor, running FreeRTOS. Alternatively, a different processor, such as the Atmel SAM9G25 (available from Atmel, San Jose, Calif.) running embedded Linux could be used. Other suitable processors and operating systems are also contemplated that provide similar functionality. In some aspects, the A/D converters 210 may be implemented internal to the microprocessor 204 and may be used for voltage and current sampling.

The cell modem 120, may be an embedded cell modem, such as the Telit LE866 (available from Telit Communications PLC, Rome Italy), and may be used for communication to the server system 400. Other similar embedded modems 120, or wired Ethernet communication devices may also be used for the same purpose. Integration of the modem 120, the antenna, and the power supply 202 into a very small, weatherproof housing 212 may allow for placement in outdoor oilfield environments, or embedded into a VFD or existing equipment panel or enclosure.

An alternative aspect replaces the cell modem 120 with an Ethernet port. This Ethernet port may be used to connect the concentrator 200 to a microwave relay or other backhaul connection to the Internet, as an alternative (e.g. for areas with no cell coverage) or complementary means of connectivity. In some aspects, the concentrator 200 may be connected via the Ethernet port to an external satellite internet connection. In one aspect, a ruggedized, weatherproof device such as the Hughes 9502 M2M Remote Satellite Terminal (available from Hughes Electronics Corporation, El Segundo, Calif.) may be used to provide a low-bandwidth communication link between the concentrator 200 and the server system 400.

Measurements from the concentrator 200 (e.g. RMS (root mean square) voltage, current, power, various production pressures, temperatures, motor speed and torque, valve position, etc.) may be taken once per second or at other reading intervals. The concentrator 200 may collect these readings until enough are gathered to efficiently compress the data. Collection periods can be any time (e.g. 1 minute, 5 minutes, and shorter or longer periods). When the collection period is reached, the compressed packet is sent to the server system 400. The readings may also checked against stored thresholds, and if a threshold condition is met, an alert or alarm condition is entered. Upon entering an alarm state, the concentrator 200 immediately sends a status update to the server system 400, along with any buffered measurement data. In aspects, an adjustable averaging window may be applied to the periodic data, and thresholds applied to the averaged data instead. Buffered data is also sent immediately upon request from the server system 400. The concentrator 200 may also be placed in a “burst” mode upon command from the server system 400, which causes the concentrator 200 to stream 1 second readings continuously on a periodic basis for a period of time. This allows the display of live measurements in the web application.

The concentrator 200 may further include a voltage reducer circuit 214 and a signal conditioning circuit 216. In one aspect, the voltage reducer circuit 214 may receive an AC voltage input. In one aspect, the signal conditioning circuit 216 may receive an AC current input.

FIG. 6 illustrates an exemplary process for operating a concentrator according to aspects of the disclosure.

In particular, the concentrator 200 may implement a data processing process 600. The data processing process 600 may include receiving an analog signal (line voltage, current, or the like) 602, conditioning the signal 604, digitizing the signal 606, calculating a measurement of various factors (RMS, total harmonic distortion (THD), etc.) 608, applying an averaging and conditioning of the measurement 610, and the like. The data processing process 600 may further include determining whether a trigger is met 612. If the trigger is met (yes), then the data processing processes 600 may send message to the server 614.

The data processing process 600 may further include measurement 616 and receiving of the SALR sensor readings 624. The data processing process 600 may further include determining if the buffer is full 618. If the buffer is full (yes), the data processing process 600 may compress data 620 and send data to server 622.

Additionally, the concentrator 200 may implement a server communication process 640. The server communication process 640 may include receiving a server command 642, processing the server command 644, and sending a response to the server 646.

Server System 400

The server system 400 may be hosted by a provider such as Amazon AWS. AWS is a subsidiary of Amazon.com that provides on-demand cloud computing platforms to individuals, companies, and governments, on a paid subscription basis. The server system 400 may utilize any other similar on-demand cloud computing platforms. An aspect may include a collection of Berkeley Software Distribution (BSD) or Linux-based virtual machine servers, including a server for receiving and parsing incoming concentrator 200 packets, storing received measurements, processing and sending alert emails and SMS messages, storing device, user, account, billing, and well information in a SQL database, and providing web hosting (e.g. with Apache) for the user web application. In aspects the servers are connected in a private network, with only the web host including a separate, public network interface (to allow web browser connections). The concentrators 200 may be networked inside a cell carrier private network, with a VPN connection to the incoming data collection server 400.

The data server 400 may decompress data received from the concentrators 200 and may store the measurement data. Although the data may be stored in a relational database, an aspect uses a binary file format to store individual packets. A separate combiner process may run in the background, reading the small stored packets and combining them into larger chunks (e.g. into a 24 hour chunk).

A separate background decimation process may read the chunks (e.g. 24 hour files), and any remaining raw packet files, and may create decimated files over longer time spans. In some aspects, a decimation ratio may be 16:1, 12:1, or 10:1, but other ratios can be used. The decimated data may include minimum/maximum points over the decimation range—e.g. with a 12:1 factor, 12 raw data points are consolidated into a single pair of minimum/maximum points over that time span. Further levels of decimation are used to sparse datasets of minimum/maximum pairs. When graphical data is requested from user activity in the web application, the server system 400 may select raw, combined, or decimated data at the correct decimation level to minimize data access to produce long graphs. For example, a graph of 1 second data over a month timespan would require 24×60×60×31=over 64 million points per measurement. Graphing multiple parameters over this time period could require over 1 billion data points. Sending this many points through to a web browser for an interactive graph is not practical, and rendering the graph on the server would take prohibitive machine resources. Using decimated data (e.g. 3rd level decimation with 12:1 factor=1728:1) reduces data processing requirements dramatically, and makes near-instant graphing of very large datasets practical in a web application. Data may be pre-decimated with background processes on the server system 400, or decimated on the fly from raw packet files, combined data, or partially decimated data as data is requested from the web application.

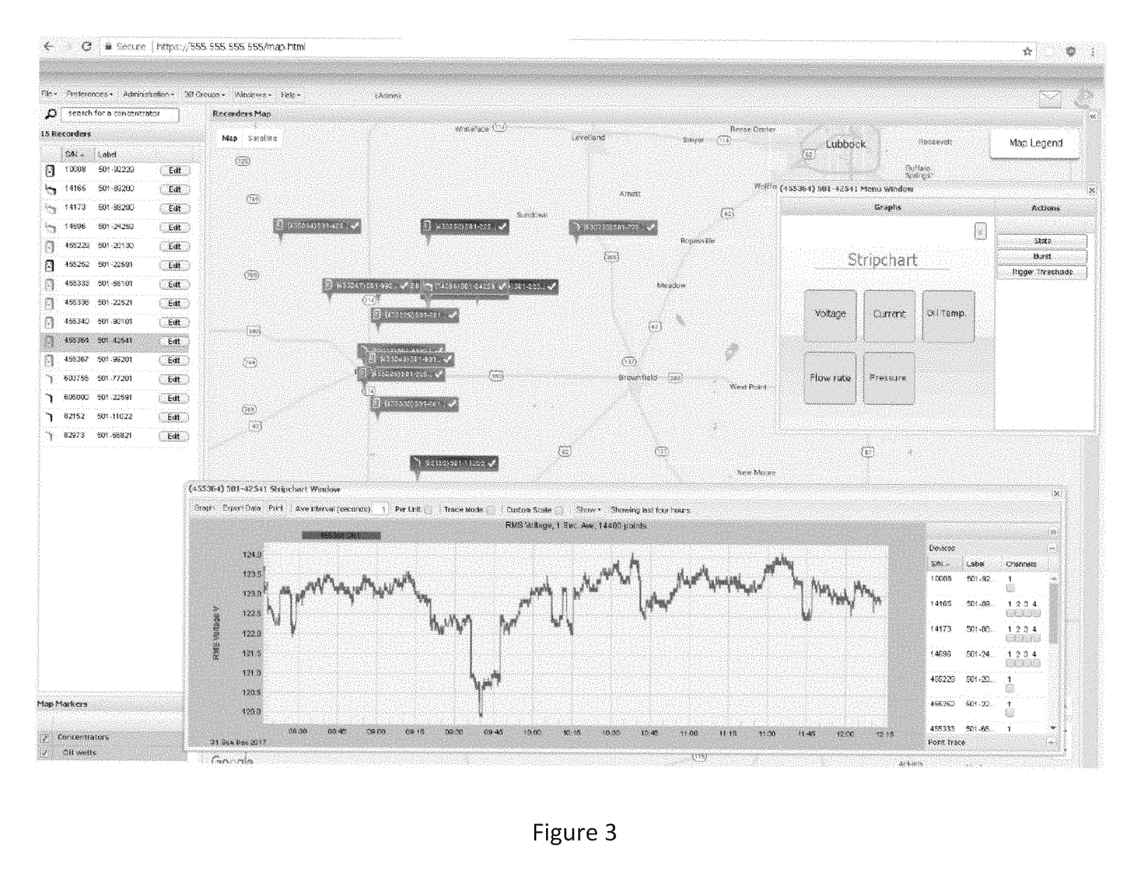

FIG. 3 illustrates an exemplary diagram of a web front end generated according to aspects of the disclosure.

The web application hosted by the server system 400 may present a map-based display of all concentrators in a user's account. The concentrators 200 may be located at well sites manually by the user, or automatically located by using a global navigation satellite system (GNSS) such as GPS, or other positioning information sent by the concentrator 200. The concentrators 200 may be automatically associated with existing wells by inputting each unique API (American Petroleum Institute) well number. The web application may automatically populate well information (operator, date of drilling/completion, workover dates, depth, etc.) by associating the API number with public records, for example from the Texas Railroad Commission. Well status may be indicated on the map using different colors or icons for the concentrator 200—e.g. pump active, valve open/closed, alarm state entered, etc. Predictive calculations such as estimated well lifetime, probability of pump cavitation, etc. may also be indicated graphically through icons or specific coloring. Production metrics such as true flow-rate (as measured by surface flow meter), estimated flow-rate (based on measurements of pump/motor on time), well pressure and/or temperature may be displayed graphically and be indicated as under/normal/over range by different colors. The map may also display overlays for other GIS information, including other drilling assets, weather information, historical well sites without existing concentrators, or other imported information. The operator may quickly determine aggregate production estimates using the system to display minimum, maximum or average total production in bbl/day for several wells selected across a pad, field, basin, and/or the like from within this map view.

The web application hosted by the server system 400 may provide a graphical display of detailed measurements in well diagram form when viewing data from a single well/concentrator 200. This well diagram may be formatted as a generic 2-D well schematic showing common sensor locations such as downhole annular, downhole tubing 116, surface annular/tubing 116, downhole pump inlet and outlets, production control valves on the surface and other frequently measured areas. When the user opens this detailed view, the appropriate well measurements may be populated and shown on this graphical well diagram view at a location corresponding with the actual sensor position. The simple well diagram may aid in rapid understanding of the locations of all measured parameters in a particular well and zones or areas of the well with under/over range sensor readings could be colored accordingly to easily recognize any problem areas within the system.

The web page may be used to request the generation of reports in various formats (HTML, CSV, PDF, etc.) These reports may be raw measurements from one or more concentrators, alert history, current well status, account billing information, etc. The reports may be rendered immediately and presented to the user in the browser, or configured to be emailed on a scheduled basis.

Distribution lists may be created for email or SMS alerts based on alarm conditions from one or more concentrators. These lists may be created and/or stored in local or remote and personal or shared systems. Separate lists may be used for different sets of alerts. Emails and text message may be text only, or include graphical information such as recent trend data from applicable measurements, to provide context and information about the alert. Notifications may be held off in aspects, so that no alert is sent if the alarm condition clears itself within a specified period of time, or aggregated so that a summary notification is sent instead of multiple separate notifications for a specified time period. The alerts may also be sent to a wireless device application configured for receiving the same. In this regard, the wireless device application (app) may be implemented by a processor of the wireless device.

The server system 400 may be configured to present an external interface, to allow a connection to a 3rd party SCADA or other control system. The external interface may be configured to use a standard SCADA protocol such as DNP or MODBUS over IP, and may be configured to present device slave addresses and point maps such that the external SCADA system may poll or send commands to the server system 400. The server system 400 may parse SCADA messages, responding as needed. These commands and queries may be for data stored on the server system 400, or require the server system 400 to issue commands to various concentrators 200. For example, an operator may send a SCADA command to operate a valve from an outside system. This command may be received by the server system 400, processed, and relayed to the applicable concentrator 200 that is connected to the desired valve. The concentrator 200 may pass the command to the valve, and they return any response back to the server system 400, which in turn responds to the outside system.

An aspect may use JavaScript executing in the user's local web browser to query the server system 400 for active concentrators 200, status, and other information needed to render the map-based display and any alerts or icon information. The browser JavaScript may periodically poll the server system 400 for changes in device status (e.g. every 5 seconds), so any change in state is reflected on the live map. The web application may present a UI to allow the user to select one or more concentrators 200, so that their data may be viewed graphically. Asynchronous JavaScript and XML (AJAX) requests from the JavaScript code are generated that request measurement data from the server system 400 as needed. These requests may include concentrator ID, timestamp, measurements needed, current viewport size, session information, and the like so that the server 400 may collect and possibly send decimated data back to the requesting code. The server-side code for handling requests is ideally written in PHP and C/C++.

Smart Artificial Lift Receiver

The Smart Artificial Lift Receiver (SALR 500) may be an optional component to the system of the disclosure. With the SALR 500, commercially available downhole sensors 106 may be incorporated into the system of the disclosure. These sensors 106 may measure production pressure and temperature, flow rate, motor parameters such as speed, torque, bending moment, and vibration, flow rate, and other parameters. This data may be sent to corresponding sensor receivers at the top of the well via standard power line communications, acoustic, RF, wired gauge telemetry protocols, wired or wireless communication channels as defined herein, and the like.

The SALR 500 may be configured as a device that interfaces with the sensor receivers, collects measurements, and sends them to the concentrator 200. The SALR 500 may configured to act a data bridge between the sensors 106 and the concentrator 200, and may be configured to present a common interface to it. The connection from the concentrator 200 of the SALR 500 to a primary concentrator 200 may be through standard MODBUS, Ethernet, or other link. The SALR 500 may be located inside or near modules as a platform. In one aspect, NetBurner modules may be configured in placed within or nearby the various commercially available sensor receivers and provide a serial data interface, easily configurable to different OEM's communication protocols, as a measurement input to the SALR 500. Other aspects may use an architecture similar to the concentrator 200, but without the analog voltage and current measurements and cell modem 120. In another aspect, the functions of the SALR 500 and the concentrator 200 may be combined into one device.

Once the concentrator 200 receives sensor data from the SALR 500, it may be configured to be processed in a similar fashion to other measured inputs, such as RMS voltage—aggregated over a short time period, compressed, and sent to the server 400. These external sensor readings may also be used to trigger alert conditions or used in burst mode.

FIG. 8 illustrates an exemplary process for operating a web server on the server system according to aspects of the disclosure.

In particular, as illustrated in FIG. 8, the server system 400 may implement a Web server operation process 800. The Web server operation process 800 may include receiving a request from a computing device web browser 802 and retrieving data from the database and file system through query processes 804.

The Web server operation process 800 may include determining whether a query or a command to the concentrator is needed 806. If the Web server operation process 800 determines that a query or a command to the concentrator is needed 806, the Web server operation process 800 may send a message to the concentrator 808 and may receive a concentrator response 810. Thereafter, the Web server operation process 800 may form a web response 812 and may send a response through the internet to web browser 814.

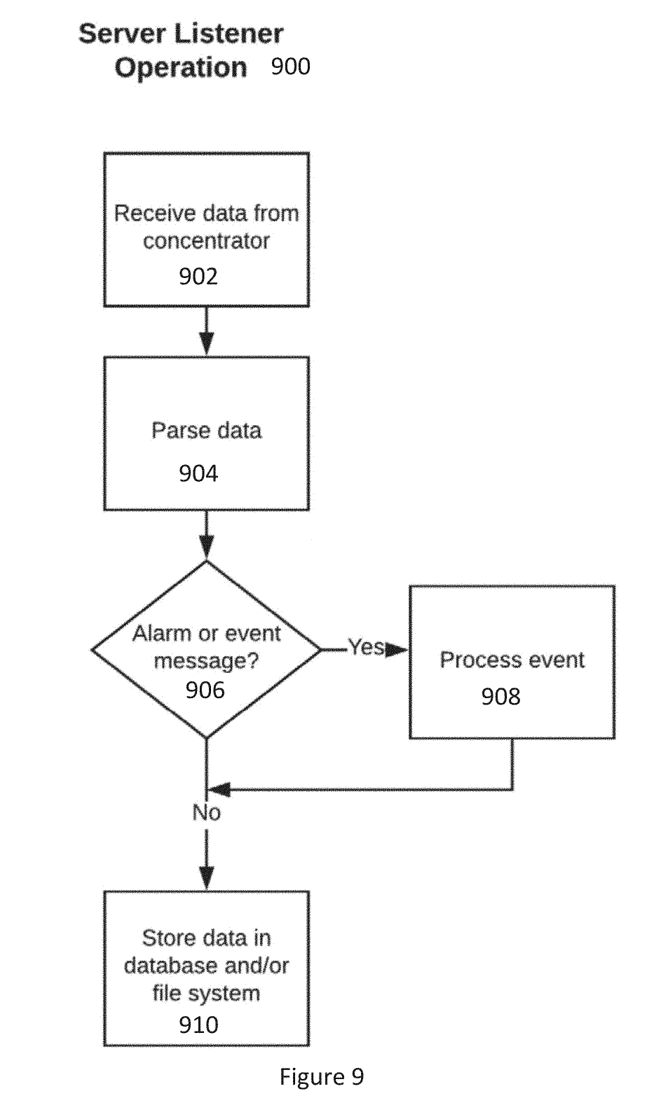

FIG. 9 illustrates an exemplary process for receiving data from a concentrator at the server system according to aspects of the disclosure.

In particular, as illustrated in FIG. 9, the server system 400 may implement a server listener operation process 900. The server listener operation process 900 may be implemented by the server 400. The server listener operation process 900 may include receiving data from the concentrator 902 and may include parsing the data 904.

The server listener operation process 900 may further include determining whether there is an alarm or event message 906. If there is an alarm or event message (yes), then the server listener operation process 900 may process the event 908. Thereafter, the server listener operation process 900 may store data in the database and/or the file system 910.

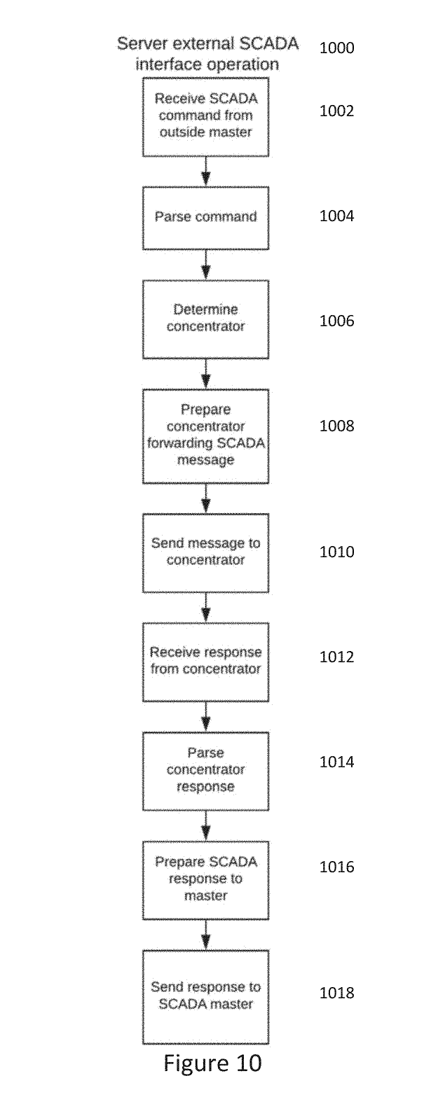

FIG. 10 illustrates an exemplary process for operating an external interface on the server system according to aspects of the disclosure.

In particular, as illustrated in FIG. 10, the server system 400 may implement a server external SCADA interface operation process 1000. The server external SCADA interface operation process 1000 may include receiving a SCADA command from an outside master 1002, parsing the command 1004, determining a concentrator 1006, preparing a concentrator forwarding SCADA message 1008, sending the message to the concentrator 1010, receiving a response from the concentrator 1012, parsing the concentrator response 1014, preparing a SCADA response to the master 1016, and sending the response to the SCADA master 1018.

System Billing and Pricing

The system allows for various methods of billing and account for use. In one setup user may purchase a site license that covers unlimited use for a certain period of time. Other users may be billed incrementally based on a number of active concentrators 200 or active wells 100. Others may be billed with even more granularity, based on number of graphs generated, command sent, or reports generated. A combination of methods may be used for some accounts.

Additional Aspects

Location Awareness

The basic system may be augmented with additional features. For example, the concentrator 200 may include a GNSS module, such as a GPS module, to determine location. The concentrator position may be sent to the server system 400 so that the device may be located automatically on the displayed map. The server system 400 may also use the concentrator 200 position information to automatically associate it with a known well site, either stored in the server database 410 or lookup in public records (such as the Texas Railroad Commission) by correlating physical location with unique API well number information. If the concentrator 200 is moved to a new well site, the server may automatically detect this change, adjust the displayed device location, and associate the concentrator 200 and new incoming data with the new well site. Graphs and reports from received data may be grouped and analyzed by well ID in addition to by specific concentrator ID.

Existing SCADA Interface

The concentrator 200 may be configured and augmented to interface directly with the external sensors 106, either existing, or installed afterwards. With the addition of a MODBUS, DNP3 (Distributed Network Protocol), or other standard SCADA protocols via RS-485, RS-232, or Ethernet, the concentrator 200 may be configured to poll other devices on a periodic basis to gather measurements or status information from sensors 106, the artificial lift Motor Controller 112, valves, or other well/pump equipment. This data may be collected and processed in a similar fashion to the native voltage and current measurements.

In addition to using a communications port for interfacing to external sensors 106, the concentrator 200 may be configured to allow control and query commands to be transferred from the server, through the concentrator 200, to external equipment. For example, a user working with the web application hosted by the server 400 may configured to allow a user to send a control command to open or close a valve, adjust a parameter on the artificial lift Motor Controller 112, read equipment status, and/or the like. The server 400 may be configured to present a graphical user interface to the user with this functionality. The server 400 may be configured to convert the UI requests to the appropriate SCADA messages and may be configured to send the messages to the concentrator 200, and may be configured to wait for the response. The concentrator 200 may be configured to receive the messages, perform any processing or format changes as needed, send the commands or queries through the SCADA port to the external equipment, wait for the response, and the like. When a response is received, the concentrator 200 may be configured to package it and send it back to the server 400. The server 400 may be configured to receive the response, parse it, update the user interface accordingly, and the like. This gives the user real-time control and status through a web browser to remote wellsite equipment. In an aspect, the server 400 may be configured to maintain a list of known equipment types, SCADA command sets, point maps, and/or the like. This may be preprogrammed, or created by the user. In one aspect, the concentrator 200 may be configured to route SCADA messages bidirectionally between connected devices and the server 400 transparently. In other aspects, specific external device information such as SCADA address, point map information, etc. may be programmed into the concentrator 200 itself.

Preventative Maintenance Analysis

In the standard aspect, the concentrator 200 may be configured to monitor the supply side of the AC current supplied to the Motor Controller (MC) 112. In aspects, a Rogowski coil, iron-core CT transducers, and the like may be connected to a multi-channel current input port on the concentrator 200. These transducers, along with the AC voltage inputs, allow the concentrator 200 to monitor RMS voltage supplied to the MC 112 by the electric utility 114, the RMS current drawn by the MC 112, and the like. These RMS readings may be computed at intervals (e.g. once per second). In another aspect, the raw voltage and current waveforms may be used to compute power quality metrics such as total harmonic distortion, voltage sags, voltage and current unbalance, and harmonic and interharmonic levels, and the like. These readings may be sent to the server system 400 on a periodic basis, and used in a manner similar to the standard measurements. Metrics such as voltage to current unbalance ratio, voltage notching, even harmonic levels, and other measures may be computed and used to predict impending MC 112 failure. For example, a change or significant increase in the voltage to current unbalance ratio may indicate higher-than-normal impedance in a particular diode in an MC's VFD bridge rectifier, and impending rectifier failure. These predictions may be computed by the concentrator 200, or in an aspect, by the server system 400. Baseline values and voltage/current waveform parametric pairs may be stored in the server system 400 and used to compare with recent readings to help determine MC 112 and pump 102 status, or the need for preventative maintenance.

Production Flow Rate Estimation

When used with a common beam or sucker-rod lift system, the concentrator 200 may be able to compute oil production flow rate based on analysis of the motor current waveform and knowledge of the pump bore and stroke. One particular advantage of this aspect is the ability to measure flow rate on legacy sucker-rod lift pumps without interrupting production by installing only the concentrator 200 at the electric motor 108. This information may be sent to the server system 400, and included in graphical and text based reports and status. In a minimal aspect, features unneeded for production flow rate estimation (such as AC voltage measurement or accessory communication ports) may be removed.

True Pump Current Analysis

In one aspect, the concentrator 200 may be configured to include current transducers on the output side of a MC's VFD, allowing the motor current to be monitored at the actual pump 102 in an ESP lift system. These readings may be sampled at a rate fast enough capture changes in motor current due to varying pump load, especially due to cavitation or other vibrations (e.g. in kiloHertz or tens of kiloHertz range). Vibration due to cavitation, motor shaft unbalance, or other mechanical problems may be identified by real-time or post-analysis of the raw motor current waveforms with the sensors 106. The concentrator 200 may be configured to compute the current spectrum to identify periodic vibration components. Spectral patterns such a cavitation fundamental frequency and harmonic and subharmonic components may be identified by the concentrator 200, resulting in an alert sent to the server system 400, allowing for email or SMS notification to users.

A further aspect allows for some autonomous control by the system. For example, rules may be programmed to direct the concentrator 200 to shut off the pump 102 or operate a valve based on sensed conditions such as flow rate, detected cavitation, incoming voltage quality problems, and/or the like. The decision logic may be configured by the user in the web application user interface, but the logic may be executed in the concentrator 200, and/or the server system 400, as needed. Applying decision logic may allow advanced equipment protection by detecting dangerous conditions and stopping a pump 102 before damage occurs. Indication of automatic operation may be presented in the map based display with differing icons or colors. In one aspect, SMS or email notifications may quickly alert operators to the shutdown and allow corrective action to be taken.

It should be noted that any of the measurements set forth in the disclosure including those by the sensors 106 may be defined as oil related data. It should be further noted that any of the components set forth in the disclosure may define oil well equipment.

Accordingly, the disclosure has disclosed solutions for providing accurate and timely information and data points concerning oil and gas wells employing artificial lift systems. The solutions including, monitoring artificial lift status and current operating conditions that reveals important information about the pump or lift system health, as well as the well itself. Further, the disclosure has disclosed configurations to measure and analyze sensor data such as pressure, flow rate, temperature, etc. at the top of the well, and downhole, that allows for advance notice of equipment failures and precise tracking of the well condition. In particular, the disclosure has set forth a centralized, cloud-based system for receiving, storing, and analyzing this data, and sending real-time alerts (including but not limited to, e.g., e-mail and SMS) based on specific conditions, that greatly improves the current state of the art in hydrocarbon production. However, it should be noted that the various aspects of the disclosure provide similar capabilities in other similar applications.

The many features and advantages of the disclosure are apparent from the detailed specification, and, thus, it is intended to cover all such features and advantages of the disclosure which fall within the true spirit and scope of the disclosure. Further, since numerous modifications and variations will readily occur to those skilled in the art on study of these disclosures, it is not desired to limit the disclosure to the exact construction and operation illustrated and described, and, accordingly, all suitable modifications and equivalents may be resorted to that fall within the scope of the disclosure.

As may be appreciated by those skilled in the art, the illustrated structure is a logical structure and not a physical one. Accordingly, the illustrated modules can be implemented by employing various hardware and software components. In addition, two or more of the logical components can be implemented as a single module that provides functionality for both components. In one aspect, the components are implemented as software program modules.

Aspects of the disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, Near field communication (NFC), a cellular telephone network, a Personal Communications Service (PCS), using known protocols such as the Global System for Mobile Communications (GSM), CDMA (Code-Division Multiple Access), GSM/EDGE and UMTS/HSPA network technologies, Long Term Evolution (LTE), 5G (5th generation mobile networks or 5th generation wireless systems), WiMAX, HSPA+, W-CDMA (Wideband Code-Division Multiple Access), CDMA2000 (also known as C2K or IMT Multi-Carrier (IMT-MC)), Wireless Fidelity (Wi-Fi), Bluetooth, and/or the like, and/or a combination of two or more thereof. The NFC standards cover communications protocols and data exchange formats, and are based on existing radio-frequency identification (RFID) standards including ISO/IEC 14443 and FeliCa. The standards include ISO/IEC 18092[3] and those defined by the NFC Forum

The disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

In an aspect, the disclosure may be web-based. For example, a server may operate a web application to allow the disclosure to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™ Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

In an aspect, the disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible non-transitory storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The term text message or SMS refers to “short message service” which is a text messaging service component of phone, web, or mobile communication systems. It uses standardized communications protocols to allow fixed line or mobile phone devices to exchange short text messages. SMS was originally designed as part of GSM, but is now available on a wide range of networks, including 3G, 4G, LTE, 5G networks or networks associated with the communication channel as defined herein. In other aspects, text message may include Multimedia Messaging Service (MMS), which is a standard way to send messages that include multimedia content to and from mobile phones. It extends the core SMS (Short Message Service) capability that allowed exchange of text messages only up to 160 characters in length. While the most popular use is to send photographs from camera-equipped handsets, it is also used as a method of delivering news and entertainment content including videos, pictures, text pages and ringtones. MMS can be used within the context of the present disclosure for UICC activation message delivery. Of note is that MMS messages are delivered in a completely different way from SMS. The first step is for the sending device to encode the multimedia content in a fashion similar to sending a MIME e-mail (MIME content formats are defined in the MMS Message Encapsulation specification). The message is then forwarded to the carrier's MMS store and forward server, known as the MMSC (Multimedia Messaging Service Centre). If the receiver is on another carrier, the relay forwards the message to the recipient's carrier using the Internet.

The term wireless data as utilized herein includes mobile broadband or wireless Internet access delivered through mobile phone towers over a communication channel as defined herein to computers, mobile phones, wireless devices, and other digital devices as defined herein using portable modems 120. Some mobile services allow more than one device to be connected to the Internet using a single cellular connection using a process called tethering.

According to an example, the global navigation satellite system (GNSS) may include a device and/or system that may estimate its location based, at least in part, on signals received from space vehicles (SVs). In particular, such a device and/or system may obtain “pseudorange” measurements including approximations of distances between associated SVs and a navigation satellite receiver. In a particular example, such a pseudorange may be determined at a receiver that is capable of processing signals from one or more SVs as part of a Satellite Positioning System (SPS). Such an SPS may comprise, for example, a Global Positioning System (GPS), Galileo, Glonass, to name a few, or any SPS developed in the future. To determine its location, a satellite navigation receiver may obtain pseudorange measurements to three or more satellites as well as their positions at time of transmitting. Knowing the SV orbital parameters, these positions can be calculated for any point in time. A pseudorange measurement may then be determined based, at least in part, on the time a signal travels from an SV to the receiver, multiplied by the speed of light. While techniques described herein may be provided as implementations of location determination in GPS and/or Galileo types of SPS as specific illustrations according to particular examples, it should be understood that these techniques may also apply to other types of SPS, and that claimed subject matter is not limited in this respect.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

The application described in the disclosure may be implemented to execute on an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like. The application may be displayed as an icon. The application may have been downloaded from the Internet, pre-installed, or the like. In some aspects, the application may be obtained from Google Play™. Android Market™, Apple Store™, or the like digital distribution source. The application may be written in conjunction with the software developers kit (SDK) associated with an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. An oil well monitoring system comprising:
a concentrator located at an oil well and the concentrator configured to collect oil well related data from oil well equipment;
the concentrator comprising a processor to process the oil well related data;
the concentrator comprising a modern to transmit the oil well related data;
a server system configured to receive the oil well related data from the concentrator; and
the server system configured to provide a web-based interface to a user that comprises at least the oil well related data.

2. The oil well monitoring system of claim 1, wherein the concentrator is further configured to measure power related data that comprises at least a voltage, a current, and a power delivered from a utility to the oil well equipment.

3. The oil well monitoring system of claim 1, wherein the concentrator is further configured to collect the oil well related data that comprises measurements from at least one sensor associated with the oil well equipment, apply user settable thresholds to the oil well related data, and respond to external commands.

4. The oil well monitoring system of claim 1,
wherein the server system is further configured to generate commands to the oil well equipment and send the commands to the concentrator;
wherein the concentrator is further configured to receive the commands to the oil well equipment from the server system; and
wherein the concentrator further comprises a command port configured to relay the commands to the oil well equipment.

5. The oil well monitoring system of claim 1, wherein the server system is configured to store all measured values as sent from the concentrator.

6. The oil well monitoring system of claim 1,
wherein the concentrator is further configured to collect the oil well related data that comprises measurements from at least one sensor associated with the oil well equipment, apply user settable thresholds to the oil well related data, and generate and send alerts to the server system; and
the server system is configured to process the alerts from the concentrator including sending immediate message notices to a distribution list.

7. The oil well monitoring system of claim 1,
wherein the server system is configured to operate with a plurality of the concentrators; and
wherein the server system is configured to provide a map-based graphical display of the concentrators.

8. The oil well monitoring system of claim 1, wherein the server system is configured to provide graphical and report-based data analysis tools for a user to view and analyze at least the oil well related data.

9. The oil well monitoring system of claim 1, wherein the server system is further configured to provide a control interface to send commands or query status of the oil well equipment connected to the concentrator.

10. The oil well monitoring system of claim 1, wherein the server system is further configured to provide a SCADA interface configured to allow an external SCADA master to query information and send commands to the oil well equipment connected to the concentrator.

11. The oil well monitoring system of claim 1, further comprising:
a smart artificial lift receiver that is configured to receive measurements from at least one sensor associated with oil well equipment; and
the smart artificial lift receiver is further configured to be directly linked to the concentrator and transmit data to the server system.

12. An oil well monitoring system comprising:
a concentrator located at an oil well and the concentrator configured to collect oil well related data from oil well equipment;
the concentrator comprising a processor to process the oil well related data;
the concentrator comprising a modem to transmit the oil well related data;
a server system configured to receive the oil well related data from the concentrator; and
the server system configured to provide a web-based interface to a user that comprises at least the oil well related data,
wherein the concentrator is further configured to measure power related data that comprises at least a voltage, a current, and a power delivered from a utility to the oil well equipment;
wherein the concentrator is further configured to collect the oil well related data that comprises measurements from at least one sensor associated with the oil well equipment, apply user settable thresholds to the oil well related data, and respond to external commands;
wherein the server system is further configured to generate commands to the oil well equipment and send the commands to the concentrator;
wherein the concentrator is further configured to receive the commands to the oil well equipment from the server system; and
wherein the concentrator further comprises a command port configured to relay the commands to the oil well equipment.

13. The oil well monitoring system of claim 12, wherein the server system is configured to store all measured values as sent from the concentrator;
wherein the concentrator is further configured to collect the oil well related data that comprises measurements from at least one sensor associated with the oil well equipment, apply user settable thresholds to the oil well related data, and generate and send alerts to the server system; and
the server system is configured to process the alerts from the concentrator including sending immediate message notices to a distribution list.

14. The oil well monitoring system of claim 12,
wherein the server system is configured to operate with a plurality of the concentrators;
wherein the server system is configured to provide a map-based graphical display of the concentrators; and
wherein the server system is configured to provide graphical and report-based data analysis tools for a user to view and analyze at least the oil well related data.

15. The oil well monitoring system of claim 12, further comprising:
a smart artificial lift receiver that is configured to receive measurements from at least one sensor associated with oil well equipment; and
the smart artificial lift receiver is further configured to be directly linked to the concentrator and transmit data to the server system.

16. An oil well monitoring process comprising:
collecting oil well related data from oil well equipment with a concentrator located at an oil well;
processing the oil well related data with a processor implemented by the concentrator;
transmitting the oil well related data with a modem implemented by the concentrator;
receiving the oil well related data from the concentrator with a server system; and
providing a web-based interface to a user that comprises at least the oil well related data with the server system.

17. The oil well monitoring process of claim 16, wherein the concentrator is further configured to measure power related data that comprises at least a voltage, a current, and a power delivered from a utility to the oil well equipment.

18. The oil well monitoring process of claim 16, wherein the concentrator is further configured to collect the oil well related data that comprises measurements from at least one sensor associated with the oil well equipment, apply user settable thresholds to the oil well related data, and respond to external commands.

19. The oil well monitoring process of claim 16,
wherein the server system is further configured to generate commands to the oil well equipment and send the commands to the concentrator;
wherein the concentrator is further configured to receive the commands to the oil well equipment from the server system; and
wherein the concentrator further comprises a command port configured to relay the commands to the oil well equipment.

20. The oil well monitoring process of claim 16, wherein the server system is configured to store all measured values as sent from the concentrator.
